(19) United States
(12) Patent Application Publication
(10) Pub. No.: US 2004/0236639 A1
(43) Pub. Date: Nov. 25, 2004

(54) Dynamic data collaboration

(76) Inventors: Arun Candadai, San Jose, CA (US); Trevor D'Souza, San Mateo, CA (US); Suraj Gaurav, Redmond, WA (US); Michael Li, San Francisco, CA (US); Anthony Rodriguez, Burlingame, CA (US); Vinceth Krishnan, Santa Clara, CA (US)

Correspondence Address: MCANDREWS HELD & MALLOY, LTD, 500 WEST MADISON STREET, SUITE 3400, CHICAGO, IL, 60661

(21) Appl. No.: 10/441,488

(22) Filed: May 20, 2003

(51) Int. Cl. G06F 17/60

(52) U.S. Cl. 705/27; 705/26

(57) ABSTRACT

A system and method are disclosed to effectively communicate business data to a plurality of business entities. In one embodiment, a system and method of effectively communicating supply chain management data to business entities are provided. In one embodiment, a data collaboration framework is loaded into a host server to provide one or more data collaboration models to business entities participating in the collaboration of supply chain management data. The data collaboration framework allows the creation of formulas for operating on supplied collaboration data, business rules for raising exceptions, and actions based on exceptions to be easily configured by an administrator.

### RELATED APPLICATIONS

[Not Applicable]

### INCORPORATION BY REFERENCE

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

In order to improve operating efficiencies, many companies today are interested in obtaining information related to their suppliers and customers. Of primary interest to a manufacturer is the demand of its products by its customers. The manufacturer will choose to manufacture in production quantities based on its customers demand. By doing so, the manufacturer minimizes inventory cost and the cost of capital. Depending on the product, inventory costs may be substantial. Furthermore, a product may have a low shelf life or high depreciation rate. For example, a food product may spoil in a number of days yielding an undesirable and worthless product. Computers and computer software often depreciate rapidly based on evolving and updated technologies. As a consequence, it is important that the manufacturer obtains the latest estimates from all its customers for the products it manufactures. However, these estimates are often very difficult or tedious for the manufacturer to obtain. The process of obtaining this information may involve considerable time and effort. Furthermore, the quality of this information may suffer, resulting in numerous errors.

On the supply side, a manufacturer may need to order one or more products from its suppliers in order to properly manufacture the products its customers desire. The suppliers themselves have their own time requirements for manufacturing their products. However, without one or more of these products, the manufacturer may not be able to proceed with the manufacture of its own products. As a consequence, accurate lead times for purchasing from suppliers are often critical and are incorporated in the manufacturer's purchasing decision. Again, obtaining these production schedules may be an arduous task. Because the methods of obtaining this information may vary based on the supplier, obtaining this information may be characterized by impreciseness, inaccuracies, or errors.

On the order fulfillment side, entities in a supply/demand chain may wish to send/receive information with respect to logistics such as work in process information and delivery schedules. Dissemination of this type of information by a supplier leads to better customer service and improved customer expectations. In addition, any changes or irregularities may be compensated for early in the manufacturing process.

In many occasions, a manufacturer may want to order in sufficient quantities to attain any discounts associated with quantity price points. Accurate and up to date forecasting information on the demand side may give the manufacturer the ability to take advantage of such discounts.

More importantly, demand forecast or material resource planning inaccuracies may lead to production problems for a manufacturer. This may result in failure of scheduled deliveries to its valued customers. An inability to provide a particular agreed upon quantity promised to a customer may result in decreased customer satisfaction and loss of repeat business. This may have profound effects on a company's reputation and this may affect business from other potential customers.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be found in a system and method to effectively exchange or collaborate data among business entities. These entities may comprise businesses within a supply chain such as enterprise businesses, business partners, trading partners, customers, manufacturers, distributors, manufacturer's representatives, resellers, dealers, or any business entity participating in the supply chain management of products and/or services.

In one embodiment, a data collaboration system is provided to store and execute a data collaboration framework (software) that facilitates an exchange and collaboration of business data among two or more business entities. The data collaboration system comprises a dealer network, a supplier network, a hosted service that executes the data collaboration framework, an administrator facilitating the management of the data collaboration framework, an administrative computing device, and a variety of telecommunications media providing a means for transport of business data among the business entities. In one embodiment, the business data includes information related to supply chain management such as demand forecasts, inventory levels, purchase orders, resource capacities, logistics, payment information, and the like. The collaboration of information is controlled in a secure environment by one or more administrators providing secure access to the addition or modification of one or more data collaboration models implemented. Data collaboration models are implemented by way of the data collaboration framework resident in one or more host servers located within the data collaboration system. Data relevant to a collaboration model is securely uploaded to the one or more host servers acting as a data repository for use by the data collaboration framework. The business entities collaborate using one or more data collaboration workspaces provided by way of data collaboration software residing in one or more computing devices within the data collaboration system.

In one embodiment, a method of implementing and deploying a data collaboration framework for collaborating business data among business entities is provided. A data collaboration framework is loaded into one or more host servers of a data collaboration system. An administrator executes the data collaboration framework in the one or more host servers. Subsequently, the administrator creates one or more data collaboration models by defining elements of the data collaboration model. Business data is uploaded into the data collaboration framework and incorporated into the data collaboration model. One or more rules, exceptions, and actions are easily constructed in the data collaboration model by the administrator. These exceptions and actions are implemented to notify and correct any supply chain irregularities to business entities that are affected. These business rules, exceptions, and actions are easily edited and modified by one or more authorized administrators.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram of a supply/demand chain in accordance with an embodiment of the invention.

FIG. 2 is a system illustrating the application of a data collaboration framework in accordance with an embodiment of the invention.

FIG. 3 is a diagram of a data collaboration workspace illustrating supply chain model administration in accordance with an embodiment of the invention.

FIG. 4 is an illustration of a data collaboration workspace allowing details to be specified in the creation of a data collaboration model in accordance with an embodiment of the invention.

FIG. 5A is an illustration of a data collaboration workspace allowing the type of data element to be created in accordance with an embodiment of the invention.

FIG. 5B is an illustration of a data collaboration workspace facilitating the creation of a new or existing data element in accordance with an embodiment of the invention.

FIG. 6A is an illustration of a data collaboration workspace allowing one to define a basic data element to be created in accordance with an embodiment of the invention.

FIG. 6B is an illustration of a data collaboration workspace allowing the addition of data elements in accordance with an embodiment of the invention.

FIG. 6C is an illustration of a data collaboration workspace allowing the selection of an existing basic data element in accordance with an embodiment of the invention.

FIG. 7 is an illustration of a data collaboration workspace allowing one to specify computed data element details in accordance with an embodiment of the invention.

FIG. 8 is an illustration of a data collaboration workspace illustrating the addition of rules in accordance with an embodiment of the invention.

FIG. 9 is an illustration of a data collaboration workspace allowing one to specify rule details in the creation of a data collaboration rule in accordance with an embodiment of the invention.

FIG. 10 is an illustration of a data collaboration workspace allowing one to formulate a conditional statement of a data collaboration model rule in accordance with an embodiment of the invention.

FIG. 11 is an illustration of a data collaboration workspace allowing one to additionally formulate and add conditional statements of a data collaboration model rule in accordance with an embodiment of the invention.

FIG. 12 is an illustration of a data collaboration workspace facilitating the creation of a data collaboration model rule by concatenating one or more conditional statements previously formulated in accordance with an embodiment of the invention.

FIG. 13 is an illustration of a data collaboration workspace allowing one to view and evaluate a data collaboration model rule in accordance with an embodiment of the invention.

FIG. 14 is an illustration of a data collaboration workspace allowing one to create an exception or notification in accordance with an embodiment of the invention.

FIG. 15 is an illustration of a data collaboration workspace providing a review of a previously constructed rule and its associated action in accordance with an embodiment of the invention.

FIG. 16 is an illustration of a Microsoft Excel flat file used for uploading to a data repository of a host server in accordance with an embodiment of the invention.

FIG. 17 is an illustration of a forecast data collaboration workspace in accordance with an embodiment of the invention.

FIG. 18 is an illustration of an inventory data collaboration workspace in accordance with an embodiment of the invention.

FIG. 19 is an illustration of a data collaboration workspace facilitating the searching of exceptions in accordance with an embodiment of the invention.

FIG. 20 is an illustration of an exceptions detail data collaboration workspace in accordance with an embodiment of the invention.

FIG. 21 is an illustration of an aggregation data collaboration in accordance with an embodiment of the invention.

### DETAILED DESCRIPTION OF THE INVENTION

Aspects of the present invention may be found in a system and method to provide effective and efficient collaboration of business data (hereinafter termed collaboration data) between a plurality of entities by incorporating and applying a data collaboration framework. The collaboration framework comprises a set of computer instructions (or software) resident in one or more host servers that facilitates the creation of data collaboration models incorporating business data provided by the plurality of entities. The data collaboration framework provides collaboration data to be dynamically communicated and shared among participating business entities in real time. Collaboration data stored at the host server (acting as a data repository) is shared with the participating entities by way of viewable data collaboration workspaces. A computing device such as a computer is used to display data collaboration workspaces and facilitate interaction with the host server. Collaboration with other business entities is by way of the one or more host servers. The data collaboration models of the data collaboration framework are easily modifiable through the use of simple and easy to use data collaboration workspaces.

In one embodiment, the data collaboration framework comprises a main software application and a set of software modules resident in a host server, implementing a data collaboration system to facilitate an exchange and collaboration of business data among two or more business entities. In one embodiment, the business data includes information related to supply chain management such as demand forecasts, inventory levels, purchase orders, resource capacities, logistics, payment information, and the like. The business entities collaborate using data collaboration workspaces provided by the data collaboration framework. In one embodiment, these entities may comprise enterprise businesses, business partners, trading partners, customers, manufacturers, distributors, manufacturer's representatives, resellers, dealers, or any entity in a supply chain of products and/or services. In one embodiment, the main software application of the data collaboration framework comprises an administrative main application configured to interact with various software application modules such as inventory, forecasting, order, and invoice collaboration modules. One or more business entities may participate in the collaboration, sharing, and exchange of data by way of collaboration workspaces implemented by the data collaboration framework software running on the host server(s). In one embodiment, the data viewed and exchanged between entities is provided by a web browser that is configured to connect to the one or more host servers. In one embodiment, the data collaboration framework includes a typical default implementation of data collaboration models. This default implementation includes a configuration that involves the creation, storage, and exchange of data in a way that conforms to the default model.

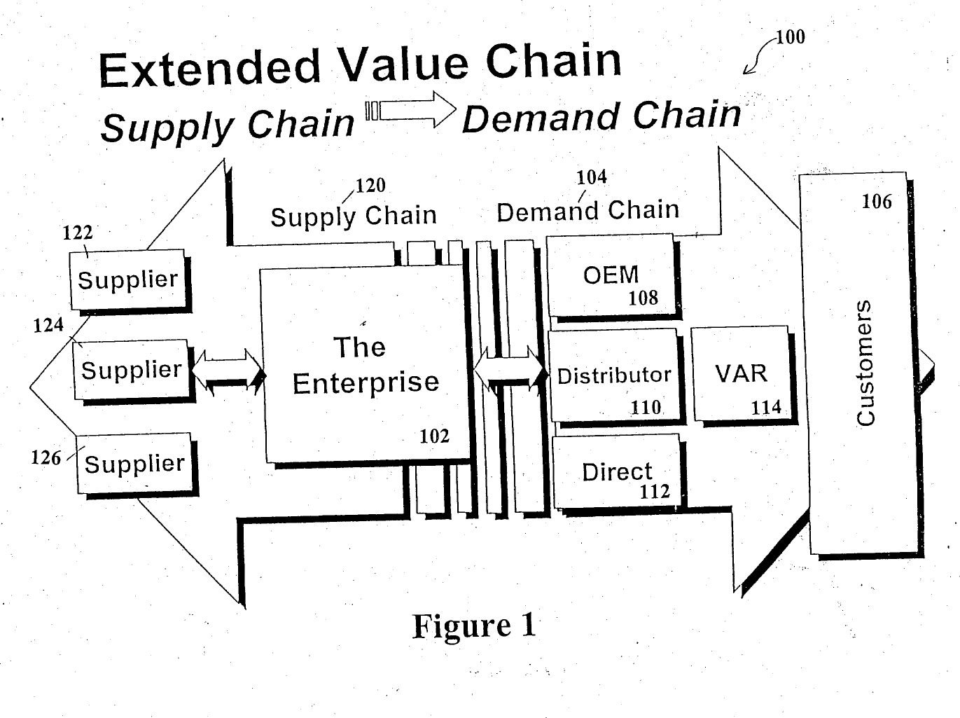

FIG. 1 is a block diagram 100 illustrating an exemplary extended value chain or supply/demand chain of the business entities previously described and their associated relationships. A demand chain 104 extends downstream from an exemplary enterprise business 102 to its customers 106. The demand chain may include intermediaries such as an original equipment manufacturer (OEM) 108, distributor 110, direct retailer 112, or value added reseller (VAR) 114. In addition to supplying products and/or services, these intermediaries may provide a service or convenience to a customer in the demand chain. Upstream, a supply chain 120 is shown with a series of suppliers 122, 124, and 126, providing products and/or services to the enterprise business 102.

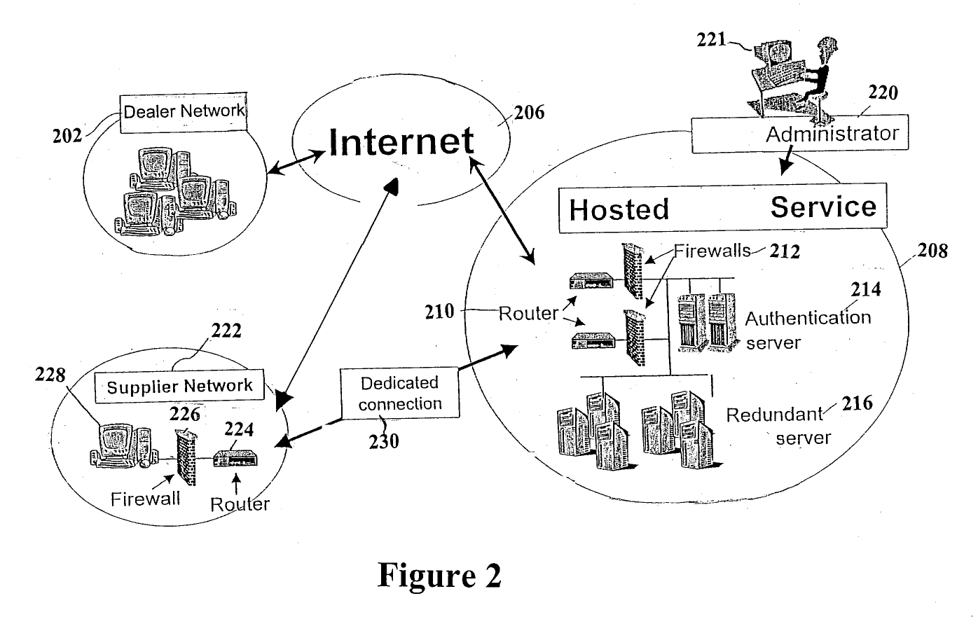

FIG. 2 is a data collaboration system illustrating the execution and application of a data collaboration framework in accordance with an embodiment of the invention. The data collaboration system comprises dealer network 202, a supplier network 222, a hosted service 208, an administrator 220 facilitating the management of the data required in the operation of the data collaboration framework, an administrative computing device 221, and a variety of telecommunications media providing a means for transport of business data. The dealer network 202 is shown interacting with the hosted service 208 by way of the Internet 206. The hosted service 208 comprises data collaboration framework loaded in one or more host servers. In the embodiment shown, one or more authentication servers 214, 216 or an administrator's computing device 221 may serve as the host server(s). The computing devices may be a computer, PDA, or any interactive digital appliance providing a graphical user interface (GUI) and a telecommunications interface. Each of the network of dealers 202 may view data collaboration workspaces associated with a particular collaboration model. The hosted service 208 relies on an administrator 220 administering one or more models of the data collaboration framework that is stored in the one or more authentication servers 214, 216 or in the administrator's computing device 221. In addition to running the data collaboration framework, the authentication servers 214, 216 and/or the administrator's computing device 221 may act as one or more data repositories for the storage of collaboration data provided the administrator or business entities. In this example, the hosted service 208 connects to the Internet by way of exemplary routers 210 and firewalls 212. The authentication server 214 authenticates a remote user, such as an off-site administrator to make modifications or additions to one or more data collaboration models. The administrator 220 of the hosted service 208 may provide maintenance of the system and participate in dynamic interaction with clients over the data collaboration system. The redundant server 216 provides data redundancy to the one or more authentication servers 214. The hosted service 208 may communicate to other business entities by way of a telecommunications media such as the Internet 206, a dedicated connection 230, a wireless connection, or any other secure connection. Also shown is a supplier network 222 comprising one or more suppliers' computing devices 228 capable of collaborating over the data collaboration system by way of the exemplary dedicated connection 230 to the hosted service 208. As illustrated, the supplier network 222 may collaborate with the network of dealers 202 by way of the data collaboration system provided by the hosted service 208. In this embodiment, the supplier network 222 connects to other business entities securely by way of an exemplary firewall 226 and an exemplary router 224. The firewalls 212, 226 and routers 210, 224 may be used as filtering devices to insure that any collaboration occurs only with the desired business entities. It is contemplated the exemplary data collaboration system shown in FIG. 2 is not limited to the exact configuration shown or to suppliers and dealers, and may include other configurations and/or other business entities associated in a supply chain.

The collaboration workspace provides a display and simple graphical user interface for one or more data collaboration models. The collaboration workspace provides an interactive environment provided by the data collaboration framework to communicate and share collaboration data among the plurality of participating business entities. Further, collaboration workspaces allow an authorized user such as an administrator to easily add or modify parameters associated with a data collaboration model. The data collaboration workspace is structured in such a way to effectively provide business data information such as supply chain management information to business entities. Access to one or more data collaboration models may be determined by an authorized administrator by way of username and passwords, for example.

A data collaboration model is characterized by a number of parameters that define the scope of the data collaboration model. These parameters may include a particular buyer, seller, site, and item combination. In other embodiments, the data collaboration model may be characterized by a combination of one or more of these type of parameters. In one embodiment, a collaboration workspace employs a spreadsheet-like view to group the various data elements and exception data corresponding to a particular data collaboration model. The collaboration workspace may display information regarding any exceptions (as will be discussed later), flags, and/or actions resulting from the rules acting on collaboration data. As will be discussed later, the collaboration workspace facilitates the addition and modification of any business rule or data element formulae of the data collaboration model.

Data collaboration models displayed to the user are based on parameters that define the scope of a data collaboration model. Hence, a business entity (i.e., a manufacturer or supplier) may only view or access data collaboration models for which that business entity exists in the scope of the data collaboration model. For example, if a particular buyer is not listed in the scope of a model, the model does not affect the buyer, and as a result, any associated data collaboration workspaces will typically not be provided. Similarly, a business entity may be granted access and editing rights for all the collaboration models in which it participates as a business entity.

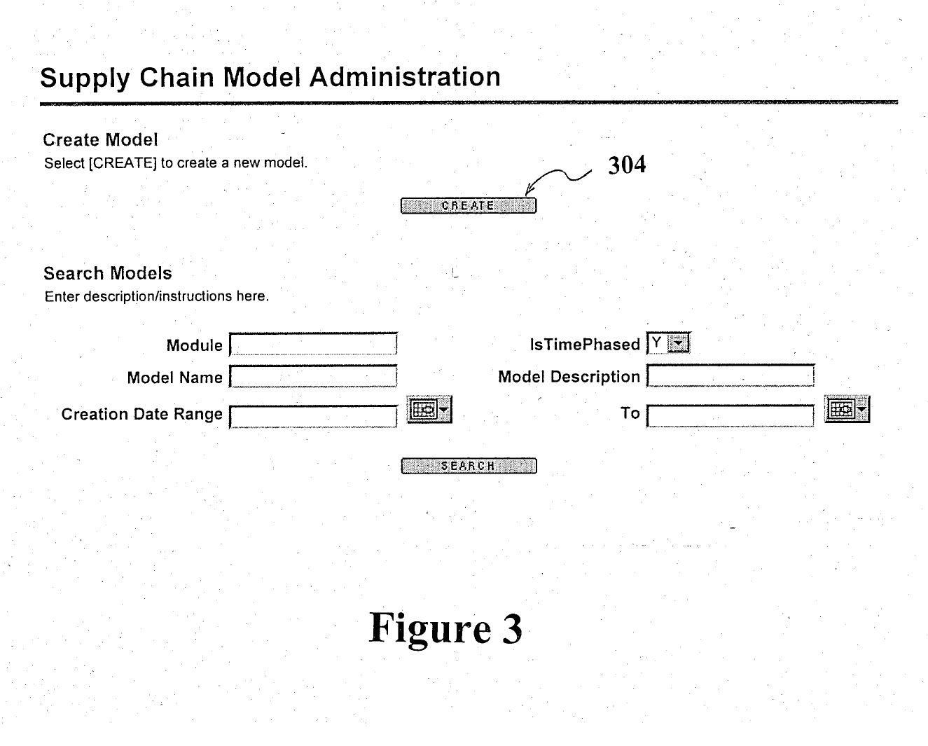

FIG. 3 is a diagram of an exemplary data collaboration workspace allowing an administrator to create a new model or search for an existing data collaboration model within its data repository in accordance with an embodiment of the invention. The administrator clicks on the “CREATE” radio button 304 shown (a radio button is a selectable area on a graphical user interface provided to invoke the action labeled on it) to invoke a collaboration workspace that allows the input of supply chain model details. Within the same data collaboration workspace, an exemplary search engine provides a search of existing models stored in the system. The search may be based on one or more selectable criteria such as module name, model name, creation date range, time phase, and/or model description.

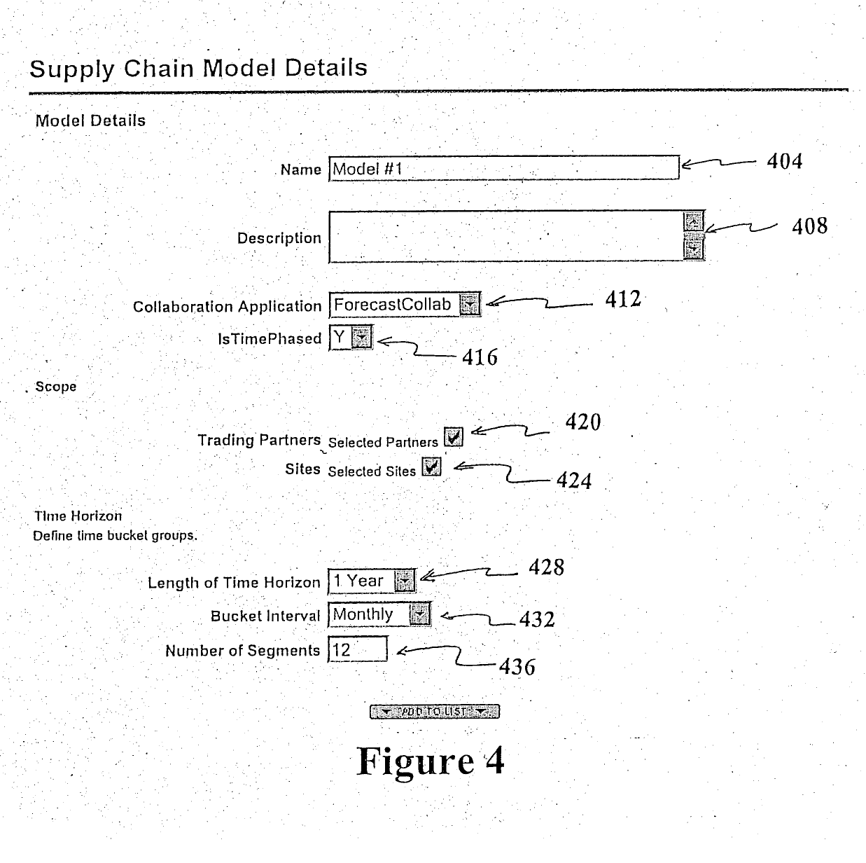

FIG. 4 is a diagram of an exemplary data collaboration workspace allowing a user to input supply chain model details when creating a new model. An administrator may provide model name 404, description of the model 408, collaboration application type 412, time phase 416, trading partner 420, site 424, length of time horizon 428, bucket interval 432, and number of segments 436 information by way of the data collaboration workspace shown. The collaboration application type 412 may be selected as an inventory collaboration, forecast collaboration, purchase order collaboration, or an invoice collaboration, for example. The collaboration application type 412 determines the type of collaboration model the collaboration framework will utilize. The time phase may be selected or deselected based on the collaboration model type selected. By selecting time phase to be displayed, time horizon information (such as length of time horizon 428, bucket interval 432, and number of segments 436) is also displayed as part of the data collaboration workspace. A time phased data collaboration workspace allows viewing collaboration data at selected times within a time horizon. The length of time horizon 428 option may be set to days, weeks, months, or years; the bucket interval 432 option may be set to daily, weekly, fortnightly, monthly, quarterly, and yearly. The number entered into the number of segments field 436 determines the number of segments the length of time horizon 428 may be divided into. The administrator may select one or more business entities (trading partners) 420 as participants in a data collaboration model. Similarly, the administrator may select one or more sites in which the data collaboration model applies. The act of selecting the appropriate business entities and sites contribute to defining the scope of the data collaboration model.

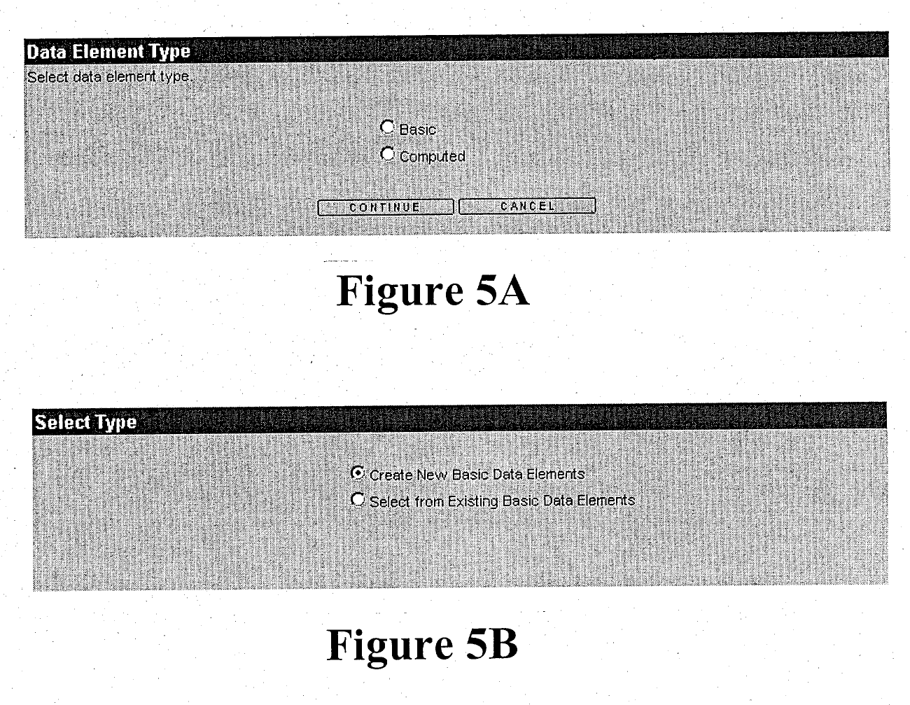

FIGS. 5A and 5B are diagrams illustrating exemplary data collaboration workspaces used to create a data element in a data collaboration model. Data elements are variables used to define the data collaboration model. At a particular instance in time, a data element comprises a value. In one embodiment, a data element has values that are displayed in a particular row of a particular collaboration workspace. The row is separated by columns that correspond to time intervals over a specified time horizon. In this instance, the number of time intervals determine the number of data element values displayed in a particular data element row. In FIG. 5A, the workspace allows an administrator to indicate the type of data element to be created. As shown, either a basic or computed data element may be created. A basic data element is characterized by one or more static values uploaded by an authorized user or administrator while a computed data element is characterized by one or more computed values computed or derived from basic or other computed data element values. By selecting the radio button associated with the creation of a basic element, the data collaboration workspace changes to that of FIG. 5B. The exemplary data collaboration workspace illustrated in FIG. 5B allows the administrator to either create a new basic element or select from a previously created basic element stored in the data collaboration framework. Defining data elements is a required step in the creation of any data collaboration model. To add data elements, you must first select either a basic or computed data element type.

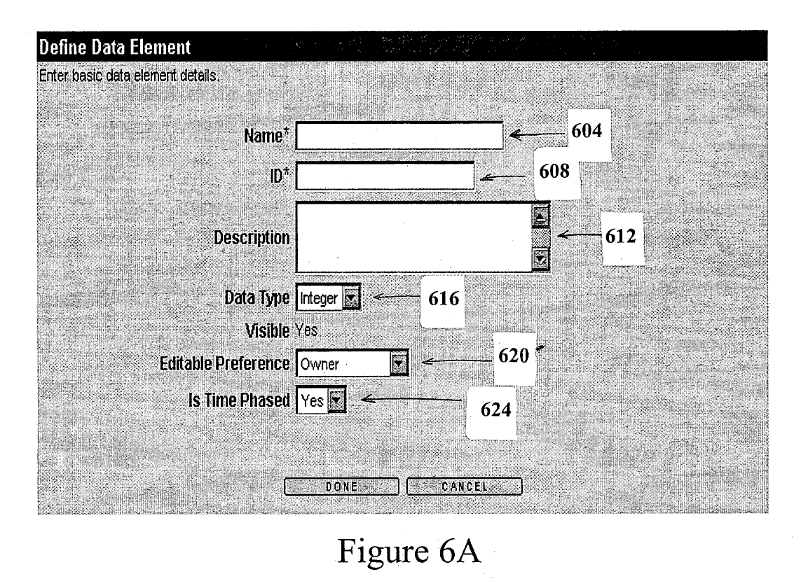

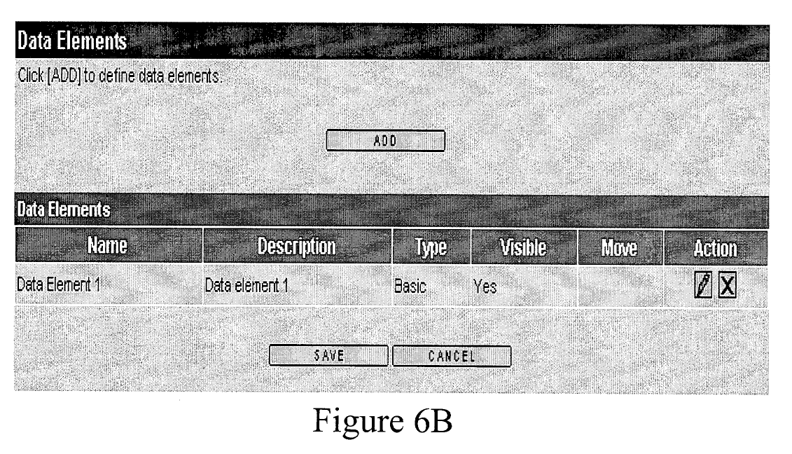

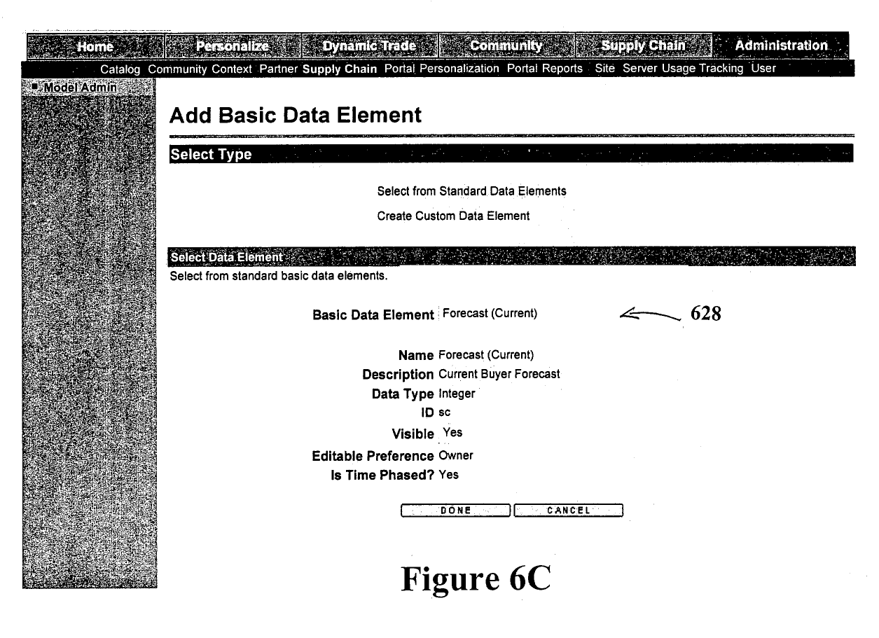

FIG. 6A illustrates an exemplary data collaboration workspace allowing an administrator to define a basic data element. A name field 604 allows the administrator to label the basic data element with a name. An ID field 608 allows the administrator to provide an identification number. A description 612 of the data element may be provided as well. As illustrated, drop-down menus may be provided to configure the data type (Integer, Float, or String) 616, editable preference 620, and time phase 624 fields. The editable preference menu may designate the person(s) who have permission to make changes to the characteristics of the data element after it is created. For example, permission may be granted to a business entity administrator (owner), trading partner, supplier, manufacturer, distributor, and the like. After all fields have been defined, the data element is stored by clicking the “DONE” radio button on the workspace.

FIG. 6B illustrates an exemplary data collaboration workspace providing additional data elements to be defined for a particular data collaboration model. This is accomplished by selecting the “ADD” radio button and repeating the process. Also illustrated in the data collaboration workspace of FIG. 6B is a summary of all data elements created for a particular data collaboration model.

FIG. 6C illustrates an exemplary data collaboration workspace enabling one to define a basic data element based on existing data element profiles for a particular data collaboration model. As illustrated, a particular basic data element may be selected from a pull down menu 628. In this example, a basic data element called Forecast (Current) is selected and the corresponding data element details are automatically populated.

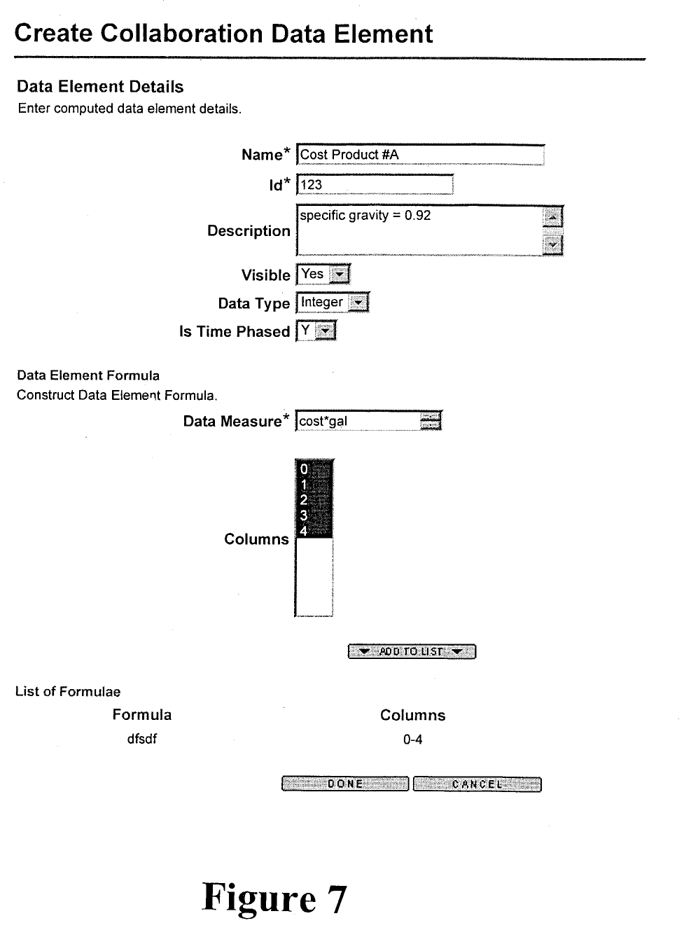

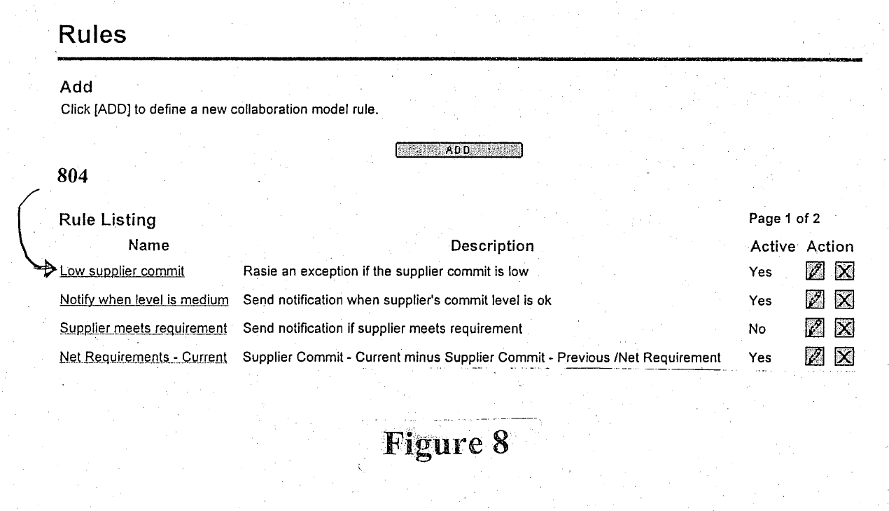

To include a computed data element in a data collaboration model, an administrator or authorized user selects the computed radio button illustrated in FIG. 5A. After selecting, the data collaboration workspace changes to that shown in FIG. 7, where an administrator may enter computed data element details in the top half of the screen and construct data element formulas (or data measure) in the lower half. A product name, identification number (Id), and description is entered by the administrator. The administrator may allow other business entities to view the data element on their collaboration workspace if “Yes” is selected by way of the pull-down menu. The data type field provides the formatting information of the computed data element. If the field “Is Time Phased” is set to “No”, the page will refresh automatically and the Columns region in the lower section will no longer appear (The Columns correspond to time intervals over a specified time horizon). When the administrator has finished entering data into the fields, he clicks the “Add to List” radio button to enter the new formula into the system. The administrator may repeat the process, creating as many formulas as required. These computed data element values are computed or derived from basic data element values or other computed data element values.

FIG. 8 illustrates an exemplary data collaboration workspace in which data collaboration rules may be added for a particular data collaboration model. This is accomplished by clicking the “ADD” radio button. Also illustrated in the data collaboration workspace of FIG. 8 is a listing of all rules previously created for a particular data collaboration model.

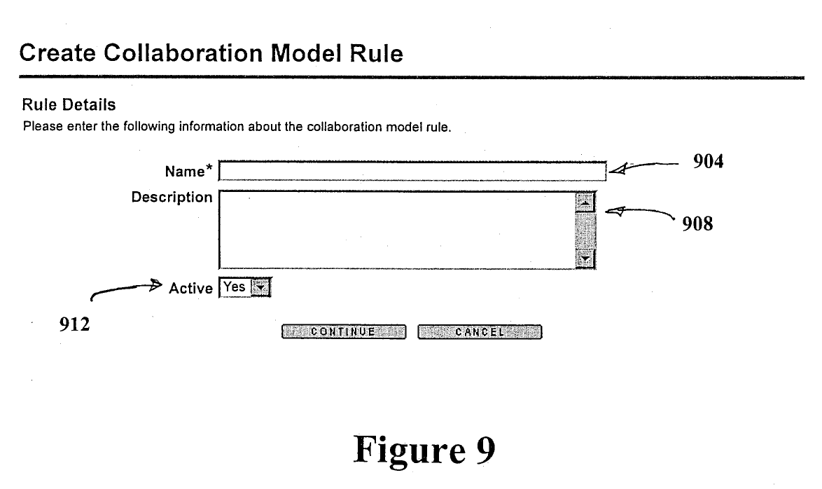

FIG. 9 is diagram of an exemplary data collaboration workspace allowing a user to input data collaboration model rule information when creating a new rule. An administrator may provide a model name 904 and a description of the model 908 to be created. He may also activate the model or save it by selecting either yes or no in the “Active” pull down menu 912.

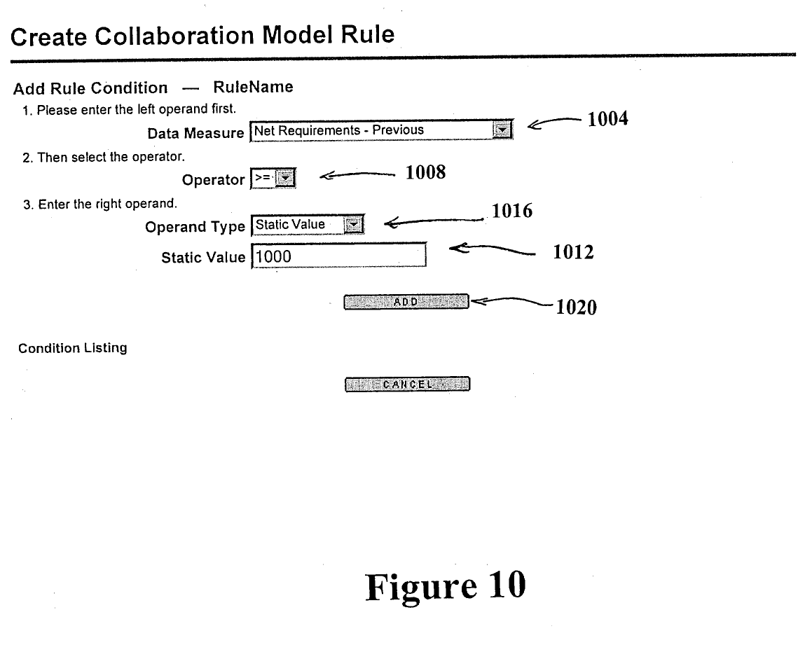

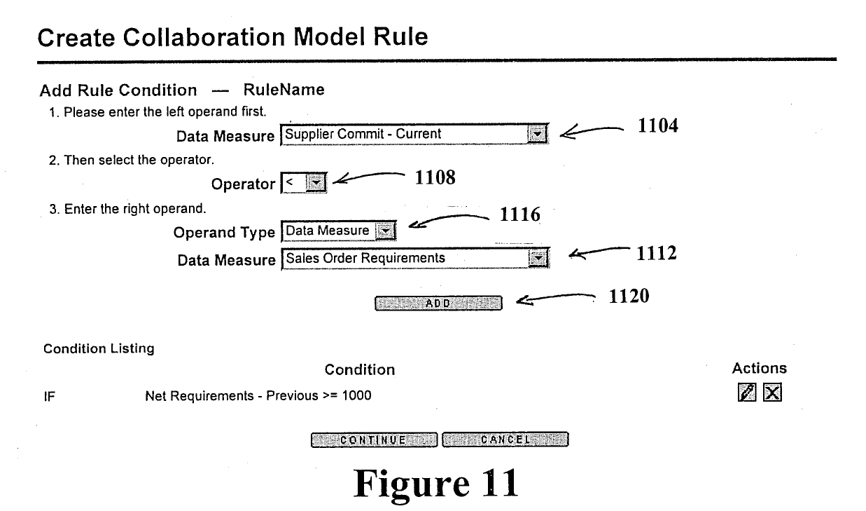

FIG. 10 is diagram of an exemplary collaboration workspace allowing a user to formulate a data collaboration model rule. An administrator may provide a name of a left operand 1004 such as a data measure or formula name, a suitable mathematical operator 1008, a name of a right operand 1012, and an operand type 1016. After all fields have been populated, the administrator selects the “ADD” radio button 1020 and the process continues with the exemplary data collaboration workspace provided by FIG. 11.

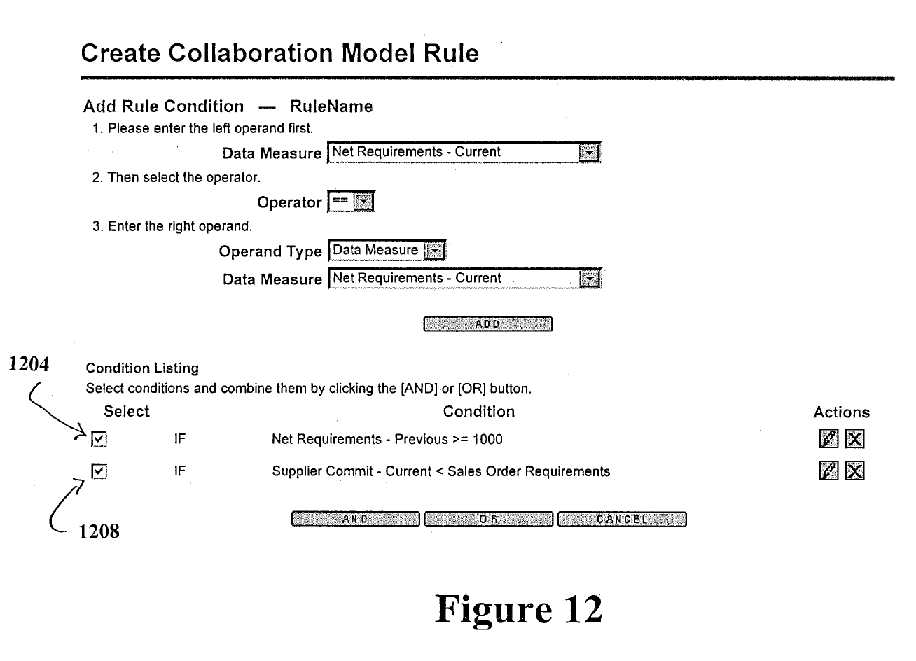

FIG. 11 is a diagram of an exemplary data collaboration workspace illustrating the conditional statement created in the data collaboration workspace of FIG. 10. In this example, the conditional statement (Net Requirements−Previous>=1000) was formulated as illustrated in the Condition Listing section of the data collaboration workspace. An additional conditional statement may be concatenated with the previously formulated conditional statement by providing a name of a left operand 1104 such as a data measure or formula name, a suitable mathematical operator 1108, a name of a right operand 1112, and an operand type 1116. After all fields have been populated, the administrator selects the “ADD” radio button 1120 and the process continues with the exemplary data collaboration workspace provided by FIG. 12.

The exemplary embodiment of FIG. 12 illustrates the two conditional statements previously created and are listed in the Condition Listing portion of the data collaboration workspace shown. In this example, an administrator selects both conditional statements to be included in the rule by selecting both radio boxes 1204, 1208 located in the Condition Listing portion of the data collaboration workspace shown. The administrator selects an appropriate operator to combine the two conditional statements. In this example, the administrator selects the “AND” operator to concatenate the two conditional statements.

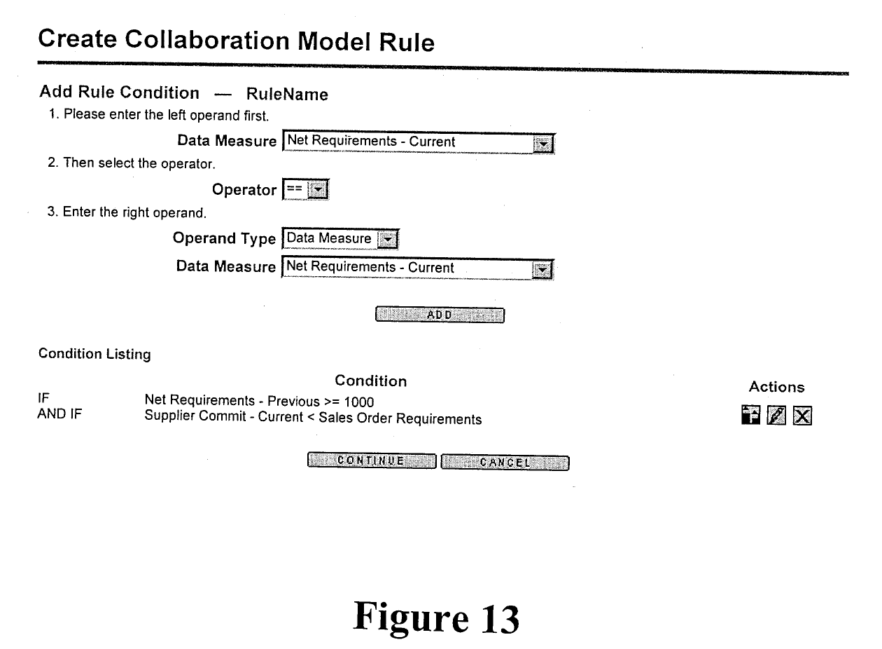

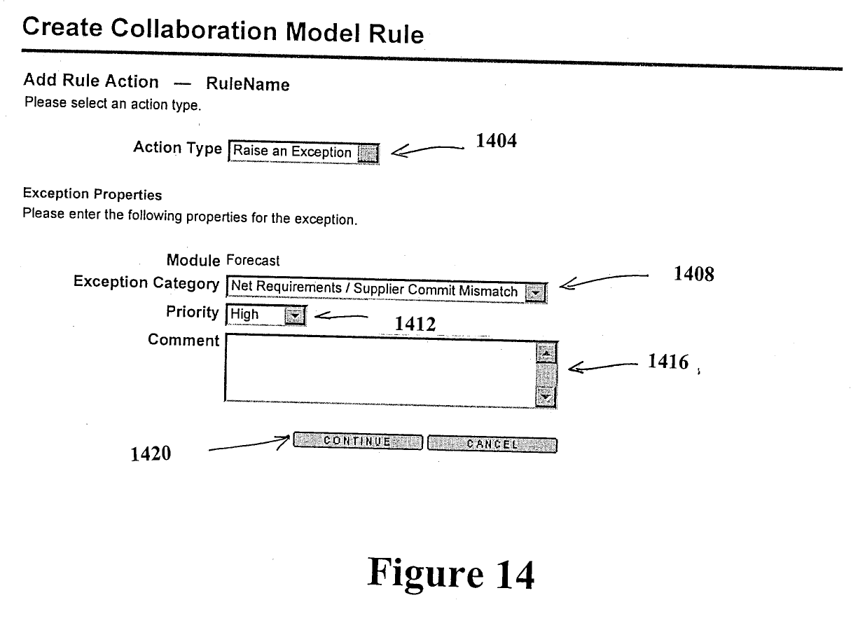

FIG. 13 illustrates the result of concatenating the two conditional statements with the “AND” operator. As shown in the Condition Listing portion of this example embodiment of a data collaboration workspace, the resulting conditional statement IF (Net Requirements−Previous>=1000) AND IF (Supplier Commit−Current)<(Sales Order Requirements) is formulated. In this example, the administrator selects the radio button “CONTINUE” to proceed to the next data collaboration workspace shown in FIG. 14.

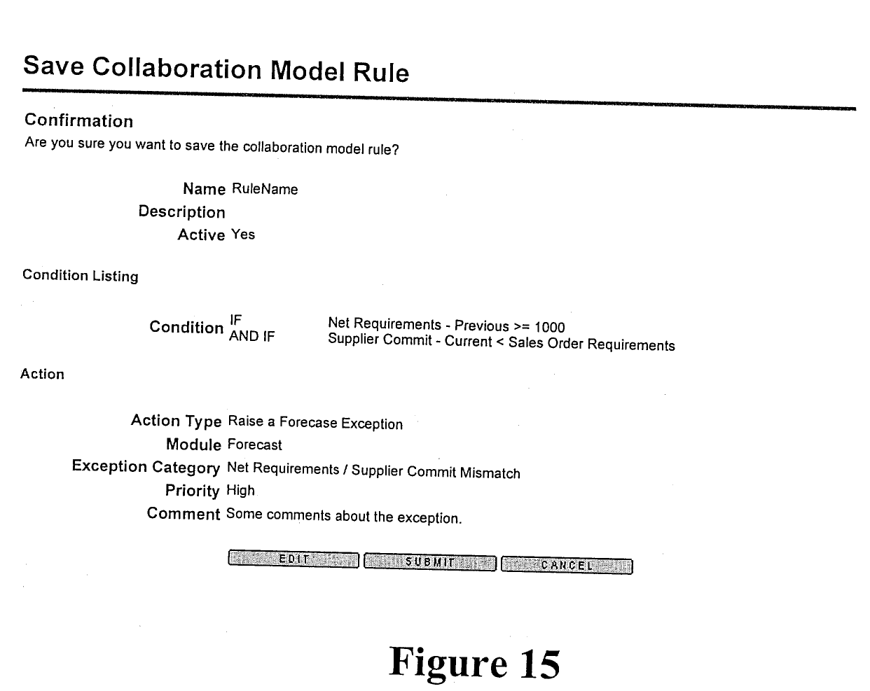

FIG. 14 is an example embodiment of a data collaboration workspace providing an administrator the ability to create an exception or notification. The exception or notification is constructed by selecting an Action Type 1404, and is invoked when the conditions of the rule are met. An administrator may select a particular Exception Category 1408 and Priority level 1412 indicator associated with the exception. Further, the administrator may supply comments or a narrative by way of a Comment field 1416. After all fields have been populated, the administrator selects the “CONTINUE” radio button 1420 and the details of the rule are displayed in the exemplary workspace provided by FIG. 15.

FIG. 15 is an example embodiment of a data collaboration workspace providing an administrator the ability to review a rule and action type previously constructed. It also provides an administrator an opportunity to make any changes by way of selecting the “EDIT” radio button. If the administrator decides there are no additional modifications to be made, he selects the “SUBMIT” radio button allowing the rule to be submitted and stored within the data collaboration model.

An authorized user such as an administrator of a host server of a data collaboration system may configure access control rules (such as generating and distributing passwords for logging into a collaboration model), formulas for operating on uploaded collaboration data, and business rules for raising exceptions/actions in the defining business processes. Any uploaded collaboration data is delivered to the host server which acts as a data repository and incorporates the data into the data collaboration framework. Collaboration data may be loaded into a data repository of the host server by real-time business process integration, near real-time batch process, or by uploading a file directly to the data collaboration host server. The following summarizes the various upload methods contemplated:

a. Real-time process integration—Collaboration data may be entered into the system using real-time process integration. Real-time process integration is essentially a mechanism in which business processes running in enterprise systems (legacy or current) interact with the data collaboration framework for the purposes of sharing data with the latter in real-time. Any standard enterprise application integration (EAI) or Web Services-based integration framework can be employed to accomplish real-time process integration.

b. Near real-time batch data integration—Collaboration data may also be entered into the system using a near real-time batch data integration. This is essentially a mechanism in which data, in close to real-time but not precisely real-time, can be loaded into the proposed system at a particular frequency. It is contemplated an FTP (file transfer protocol) application may be used to accomplish this process.

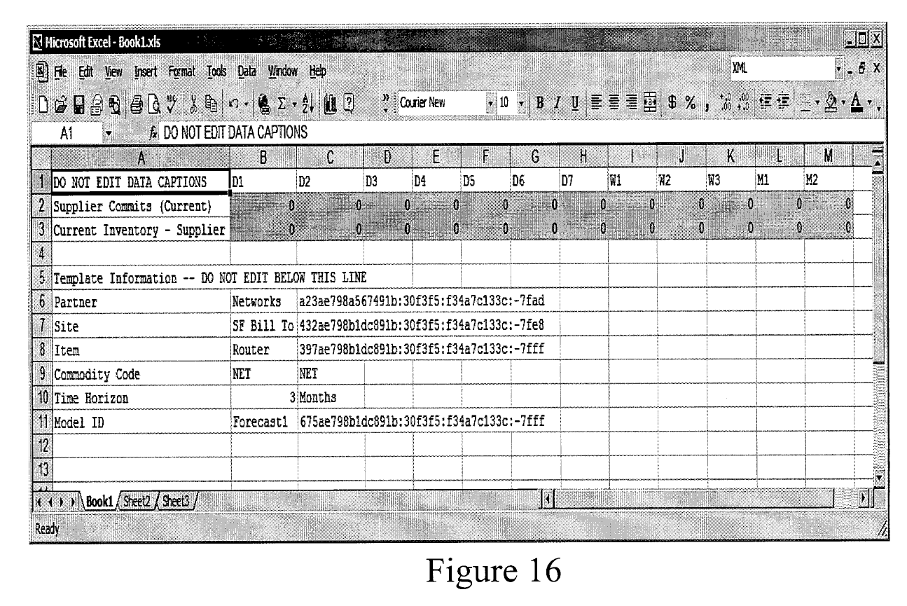

c. File upload—Collaboration data may also be manually uploaded in the form of flat files (MS Excel spreadsheet, csv, etc.). This mode is particularly useful for smaller, less sophisticated business entities that cannot provide real-time business process integration into the proposed system. FIG. 16 provides an illustration of such an exemplary Microsoft Excel flat file.

The uploading of collaboration data previously described may occur by way of transmission through a telecommunications media such as the Internet, a dedicated connection, a wide area network (WAN) connection, a local area network (LAN) connection, or other circuit or packet switched wireless or wireline connection. It is contemplated that an administrator may upload such information by way of direct input from a device such as a keyboard (i.e., a QWERTY device) connected to the host server.

When collaboration data is uploaded into the system, a collaboration evaluator of the data collaboration framework evaluates the data against its corresponding model by validating the data, generating any derived data, and finally triggering any exceptions as applicable. The data collaboration framework is responsible for all aspects of integrating data sources to properly communicate and transmit collaboration data. The data collaboration framework may invoke a transformer to convert data received from the source to a data object suitable for use by the data collaboration framework.

Exceptions originate when one or more data elements within the collaboration workspace meet certain criteria based on pre-defined business rules. These pre-defined business rules define a business decision making process. These business rules may be consistent across most collaboration models. However, in many cases, an entity will define its own business rules and/or exception categories that may differ from those of other entities. The data collaboration model continuously evaluates newly updated business data and re-computes computed data elements resulting from such updates. The values generated from these data elements are re-evaluated using these business rules and any exceptions resulting from these updates are communicated to one or more affected business entities. Typically, an exception alerts the affected business entity that a particular threshold or limit has been reached. The pre-defined business rules may trigger one or more thresholds providing different degrees of exceptions provided to the affected business entity. In general, an exception provides an alert to the affected business entity regarding the criticality of the exception. In one embodiment, the alert indicates the degree of criticality by describing the exception as high, medium, or low. In one embodiment, a corrective action is taken to manage the particular exception generated. The corrective action may comprise an e-mail message identifying the exception, a pager message, an automated telephone call, a facsimile, or a pop-up message or alert displayed in a particular collaboration workspace.

In one embodiment, the corrective action on a net requirements versus supplier commitment exception may result in automatic collaboration with one or more suppliers in order to fulfill the requirements of an order provided by one or more business entities. In this fashion, the remaining order may be addressed immediately by addressing the exception with a supplier having available inventory. Hence, demand requirements may be dynamically filled in real time. In one example, the automatic collaboration with one or more suppliers may comprise automatic purchase order fulfillment at the best available price among the one or more suppliers.

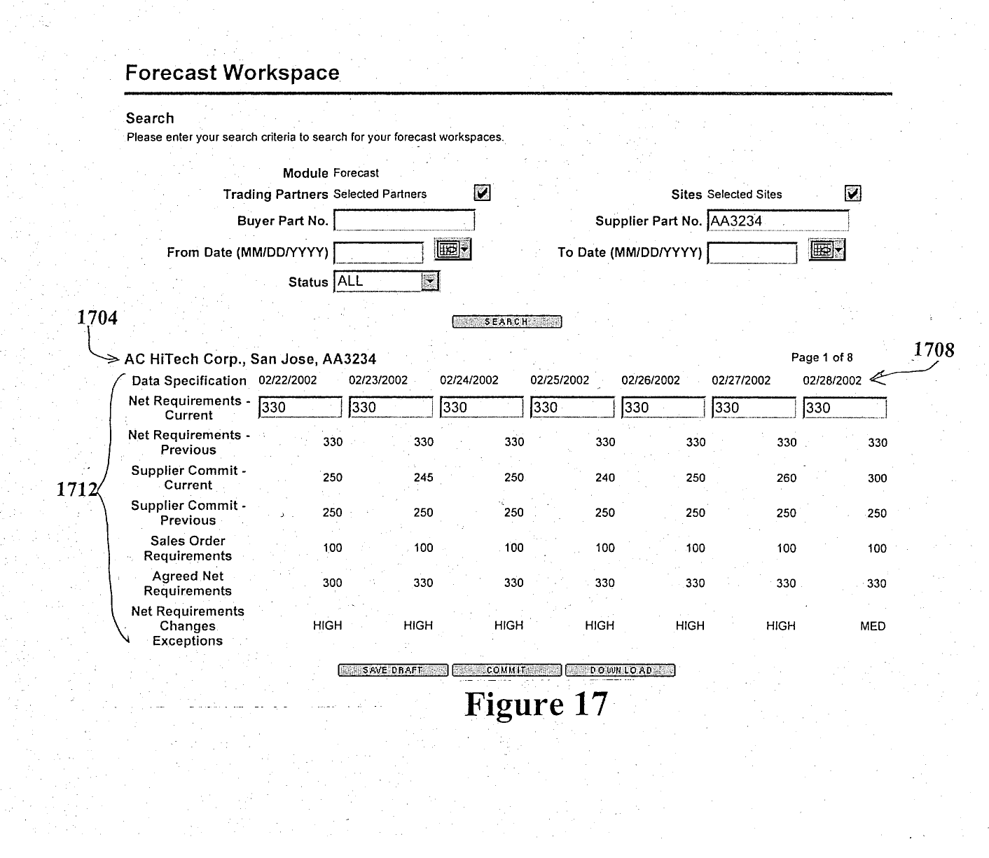

FIG. 17 illustrates an exemplary forecast collaboration workspace. In the top portion of the workspace, a search engine is provided to facilitate searching of existing forecast collaboration workspaces pertaining to a data collaboration model. The user may input one of several search criteria such as buyer or supplier product ID, specific dates, or status of collaboration data associated with the particular forecast collaboration workspace. The selectable status choices may comprise the terms draft, committed, superseded, etc., qualifying the status of the data collaboration model or collaboration data uploaded into the data collaboration framework.

Referring to the lower portion of FIG. 17, data element values are listed pertaining to the company/site name, and product identification number 1704 is listed. In this embodiment, the company/site name is AC HiTech, San Jose, while the product ID number is AA3234. The horizontal headings 1708 in the lower portion of the forecast collaboration workspace include dates corresponding to bucket intervals that were defined in its associated data collaboration model. The first column lists the various data element names 1712 while the remaining columns provide associated data element values. A data element treated as an exception is listed in the last row and labeled Net Requirements Changes Exceptions. As illustrated, the first six dates (Feb. 22, 2002-02/27/2002) are associated with HIGH exception alerts. The last date Feb. 28, 2002 is associated with a MED exception alert. Hence, in this embodiment, the degree of severity of the exception is designated by the terms HIGH, MED, or LOW. The other data elements in this exemplary embodiment are named Net Requirements—Current, Net Requirements—Previous, Supplier Commit—Current, Supplier Commit—Previous, Sales Order Requirements, and Agreed Net Requirements.

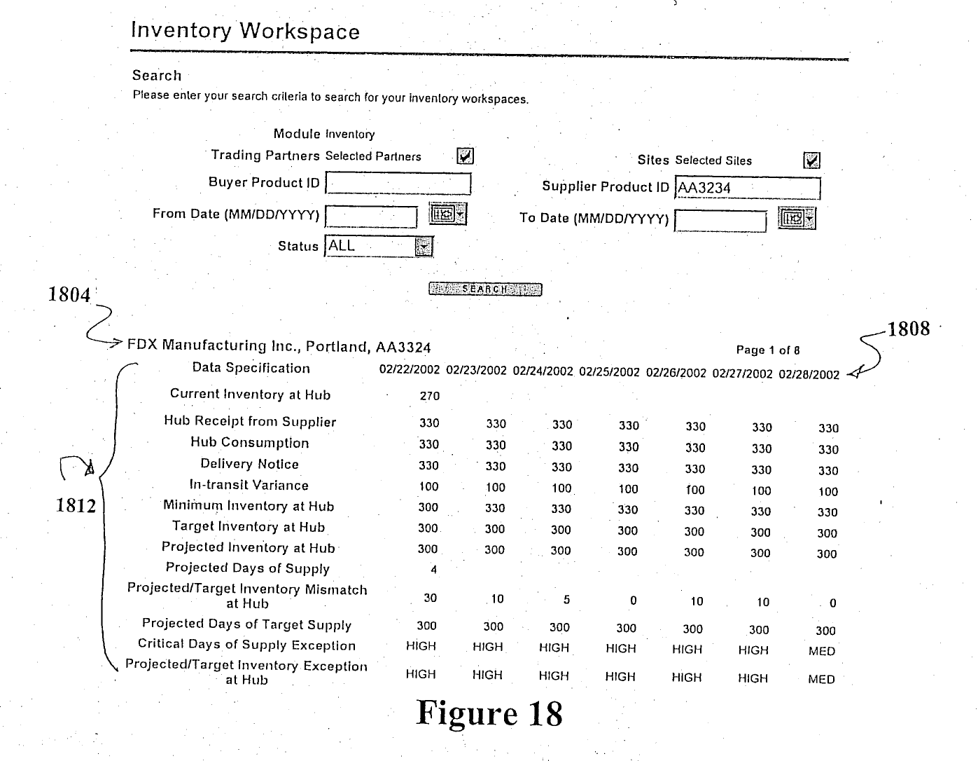

In contrast, FIG. 18 illustrates an exemplary inventory collaboration workspace. In the top portion of the workspace, a search engine is provided to facilitate searching of existing inventory collaboration workspaces pertaining to a data collaboration model. The user may input one of several search criteria such as buyer or supplier product ID, specific dates, or status of collaboration data. In the lower portion of the inventory collaboration workspace, the company name/site name and product identification number 1804 identifies the data elements listed. In this embodiment, the company name/site name is FDX Manufacturing Inc., Portland, while the product ID number is AA3324. The horizontal headings 1808 in the lower portion of the collaboration workspace include dates corresponding to bucket intervals that were defined in the collaboration model. The first column lists the various data elements 1812 while the remaining columns provide associated data element values. Two data elements are listed as exceptions in the last two rows and are labeled Critical Days of Supply Exception and Projected/Target Inventory Exception at Hub. As illustrated, the first six dates (Feb. 22, 2002-Feb. 27, 2002) are associated with HIGH exception alerts while the last date, Feb. 28, 2002, is associated with a MED exception alerts. The other exemplary data elements are Current Inventory at Hub, Hug Receipt from Supplier, Hub Consumption, Delivery Notice, In-transit Variance, Minimum Inventory at Hub, Target Inventory at Hub, Projected Inventory at Hub, Projected Days of Supply, Projected/Target Inventory Mismatch at Hub, and Projected Days of Target Supply.

In one embodiment, a data collaboration framework implements a data collaboration system incorporating the following as exemplary data collaboration exceptions, along with their associated descriptions, and their respective data collaboration modules:

| Module | Exception | Description |
|---|---|---|
| Forecast | Net Requirements/ | Indicates that the supplier |
| Collaboration | Supplier | cannot provide the quantity that |
| | Commit Mismatch | the buyer is requesting within a |
| | | certain time period. |
| | Supplier Commit | If (Supplier Commit - Current |
| | Change Exception | minus Supplier Commit - |
| | | Previous)/Supplier Commit - |
| | | Current ≧0, raise exception flag |
| Inventory | Negative Projected | If Projected Inventory at Hub is |
| Collaboration | Inventory | negative, then exception will |
| | at Hub Exception | flag ‘high’ |
| | Current/Min | If (Current Inventory at Supplier |
| | Inventory Exception | minus Min Inventory at |
| | at Supplier | Supplier) divided by Current |
| | | Inventory at Supplier <0, raise |
| | | exception flag |
| | Current/Target | If (Current Inventory at Hub |
| | Inventory | minus Target Inventory at |
| | Exception at Buyer | Buyer (Supplier Owned)) |
| | (Supplier Owned) | divided by Current Inventory at |
| | | Buyer (Supplier Owned)\| >0, |
| | | raise exception flag |
| Order | Goods Receipt/ | Buyer received fewer goods |
| Collaboration | ASN Quantity | than the supplier indicates that |
| | Exception | they shipped. |
| | Purchase Order/ | The Advance Shipment Notice |
| | ASN Quantity | (ASN) quantity is higher than |
| | Exception | the quantity indicated in the |
| | | purchase order. |
| | PG Confirmation | The buyer sent a new PO to a |
| | Delay | supplier, and they have not |
| | Exception | responded to it in the agreed |
| | | upon 24 hour period. |
| | Early Shipment | The supplier sent a shipment |
| | Exception | earlier than the supplier |
| | | committed to the buyer. |

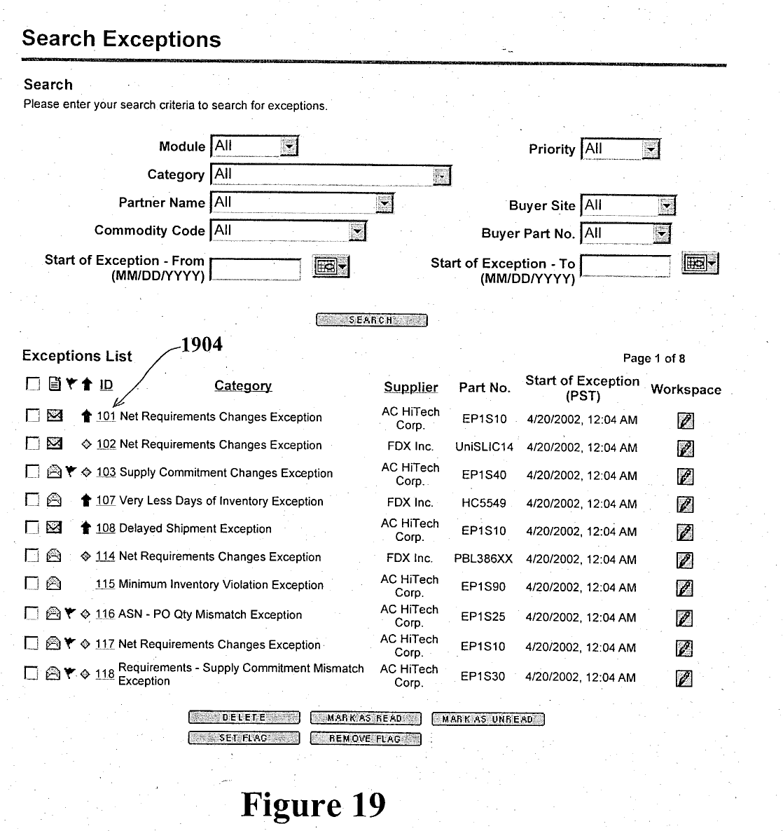

FIG. 19 provides an exemplary embodiment of a search exceptions data collaboration workspace facilitating the searching of exceptions that exist in a data collaboration framework. The data collaboration framework allows buyers to search exceptions based on different search criteria such as exception module, exception category, priority of the exception, status of the exception, supplier name, buyer site, buyer part number and the dates between which an exception occurred. Also shown is a list of generated exceptions tabulated in an Exceptions List. This exemplary outcome of exceptions may occur when the search criteria encompasses all categories in all search fields. Furthermore, the data collaboration framework may be configured to provide the following exemplary exceptions:

a. Invalid Model Exception: This exception is generated when the model becomes invalid due to inconsistencies of the definitions or values of collaboration data. For instance, in time-based worksheet collaboration, the data collaboration framework generates this exception if a time bucket is added such that the sum of all time buckets exceeds the total length of time horizon for the model.

b. Invalid Model: This exception is generated if the collaboration model defined for the collaboration is incomplete or invalid.

c. Incomplete or Missing Information: This exception is generated if there is information missing in the collaboration as indicated in a data collaboration workspace.

d. Inability to Compute Data Fields: This exception is generated if any formulas could not be executed successfully.

e. Inability to Execute Rule—This exception is generated if any rules could not be executed successfully.

f. Generic Model Exception: This type of exception may be generated for those exceptions that do not fit into a particular category.

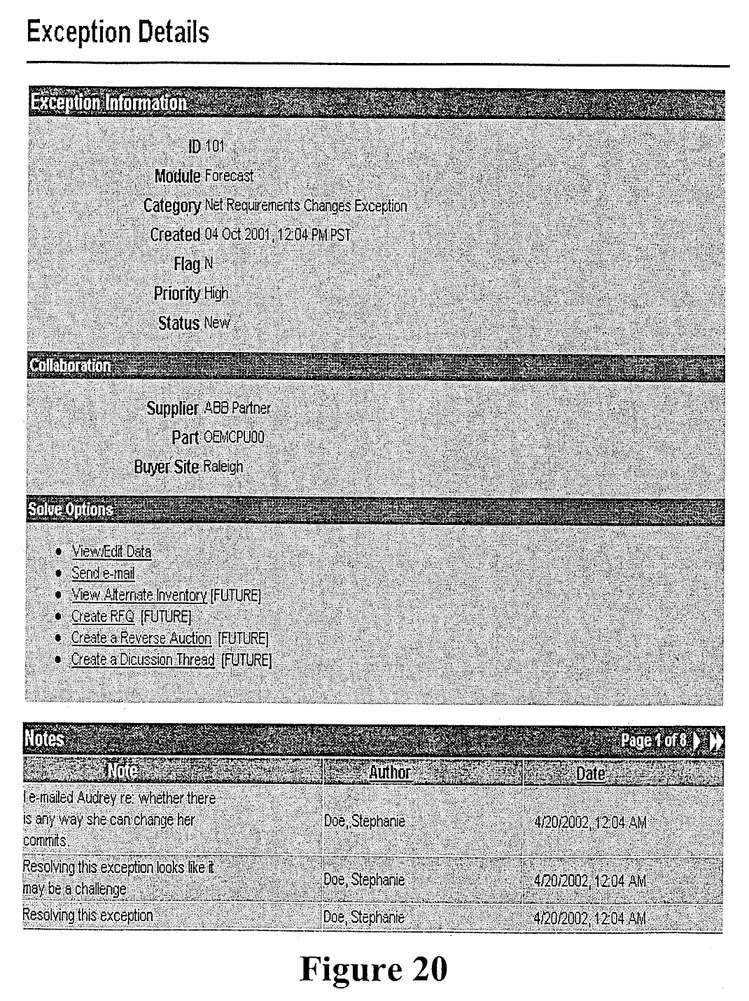

FIG. 20 illustrates an embodiment of a data collaboration workspace providing details to an exception generated by a data collaboration framework. The exemplary data collaboration workspace shown is provided by clicking on the link 1904 shown in the Exceptions List of FIG. 19. In order to insure that corrective action is performed when an exception occurs, the associated data collaboration model may continue to alert an affected business entity until such corrective action is taken. As illustrated in the lower portion of FIG. 20, the corrective actions are listed with an associated note, author, and date of the actions taken.

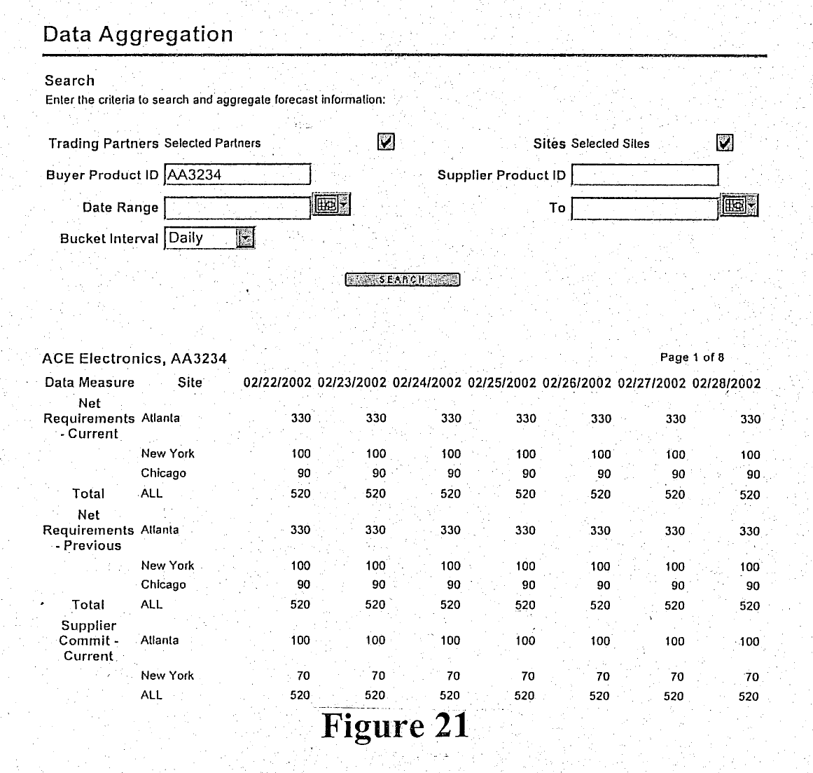

In one embodiment, the data collaboration framework provides an aggregation tool of the collaboration data across one or more sites of a particular data collaboration module. The aggregation tool may perform aggregation of one or more data elements over one or more parameters. As shown, the aggregation tool also provides totals for each data element. FIG. 21 illustrates an embodiment of a data collaboration workspace in which aggregation is performed for a number of data elements across different sites for a particular product (AA3234). As shown, aggregation of these data elements is across a number of cities (Atlanta, New York, Chicago) and results in a total (designated as ALL) for each data element.

The data collaboration framework provides a set of building blocks, in the form of business process flows and API, for developers to create and manage data collaboration models. It is contemplated the data collaboration framework is compatible with the following exemplary operating systems, data base servers, web browsers, web servers, application servers, and application programming interfaces (APIs):

Operating systems—Solaris (2.7)/NT (4.0 SP5)/Windows 2000

Database Servers—Oracle RDBMS (8.1.6)/Oracle Client (8.1.7)/SQL Server/JDBC

Web Browsers—Netscape Navigator 4.0 and Internet Explorer 4.0 and above.

Web Servers—IPlanet Webserver (NES) (4.0 SP4)/IIS (4.0 NT options pack) and above.

Application Servers—Weblogic (5.1.0 SP6)/IBM Websphere (5.0)

Data Integration—ERP system integrated/CRM system integrated

APIs Supported—HTTP/HTML/HTTP/XML/Java API (J2EE)/ORB/COM

Aspects of the invention provide one or more of the following advantages. A generic set of capabilities to effectively and efficiently exchange and collaborate data among different entities is provided. A data collaboration framework is incorporated to promote the exchange or collaboration of information among participating entities. The collaboration provides for a more streamlined business process for business entities involved in a supply chain. In one embodiment, the data that is exchanged comprises business information related to supply chain management such as demand forecasts, inventories, purchase orders, invoices, and resource capacities. The data collaboration framework provides the necessary software component building blocks and methodologies in order to effectively forecast the demand and supply of products and collaborate purchase orders and inventories. The data collaboration framework provides data collaboration workspaces which may be used to easily modify or create data collaboration models. By providing visibility and inter-enterprise collaboration capabilities of business data within a supply chain, companies can streamline their business processes to reduce their overall costs. The result is improved profitability and enhanced customer satisfaction. For example, by sharing, collaborating, and taking corrective actions based on updated demand forecast and supply commitment data, business entities may ensure that their customer demands are being met with timeliness and cost-effectiveness.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A data collaboration system to effectively and efficiently communicate business data among two or more business entities comprising:
computing devices capable of providing collaboration workspaces used by each of said two or more business entities;
a data collaboration framework resident in at least one computing device acting as a host server capable of implementing data collaboration models; and
telecommunications media providing data connectivity among said computing devices.

2. The system of claim 1, further comprising a web browser in each of said computing devices capable of displaying and interacting through said collaboration workspaces.

3. The system of claim 1, wherein said business data is accessible by said two or more business entities in real time.

4. The system of claim 1, wherein said business data is stored in said host server in real time.

5. The system of claim 1, wherein said collaboration data is stored in said host server by said two or more business entities by batch data integration.

6. The system of claim 1, wherein said collaboration data is stored into said host server by said two or more business entities by manual uploading of data files.

7. A method of implementing and deploying a data collaboration system for communicating collaboration data among business entities comprising:
storing software into a host server;
running said software;
creating one or more data collaboration models;
populating said collaboration data into said one or more data collaboration models;
computing any data elements values based on said collaboration data;
generating one or more exceptions based on business rules; and
selectively displaying said collaboration data by way of a data collaboration workspace.

8. The method of claim 7 further comprising producing an action based on said generating one or more exceptions.

9. The method of claim 8 wherein said action comprises an e-mail notification.

10. The method of claim 8 wherein said action comprises a pager notification.

11. The method of claim 8 wherein said action comprises visual notification over a computing device display.

12. The method of claim 7 wherein said creating one or more data collaboration models comprises defining the scope of the data collaboration model.

13. The method of claim 12 wherein said scope comprises a buyer, seller, site, and product combination.

14. The method of claim 7 wherein said creating one or more data collaboration models comprises defining one or more data elements for each of said one or more data collaboration models.

15. The method of claim 7 wherein said populating collaboration data comprises uploading data from a business entity to a host server.

16. The method of claim 15 wherein said uploading data occurs by way of a telecommunications media.

17. The method of claim 16 wherein said telecommunications media comprises the Internet.

18. The method of claim 16 wherein said telecommunications media comprises a dedicated connection.

19. The method of claim 16 wherein said telecommunications media comprises a local area network connection.

20. The method of claim 16 wherein said telecommunications media comprises a wide area network connection.

21. The method of claim 7 wherein said populating collaboration data comprises direct input into a host server by an administrator.

22. The method of claim 7 wherein said selectively displaying collaboration data is based on an administrator configuring which of said data collaboration models, business rules, and data elements values are made accessible to one or more said business entities.

23. The method of claim 7 further comprising alerting said business entities when an exception occurs.

24. The method of claim 23 wherein said alerting comprises e-mail notification of said exception.

25. The method of claim 23 wherein said alerting comprises visual notification of said exception by display provided by a computing device.

26. A data collaboration framework resident in a data collaboration system comprising:
a main administrative portion of software; and
one or more application software modules;
wherein data collaboration workspaces are provided that are viewable by a web browser, permitting one or more business entities to share collaboration data in real time.

27. The data collaboration framework of claim 26, wherein said web browser comprises one of Internet Explorer or Netscape Navigator.

28. The method of claim 7 wherein said generating one or more exceptions comprises automatically collaborating with one or more suppliers to fulfill demand requirements of said business entities.

29. The method of claim 28 wherein said automatically collaborating with one or more suppliers to fulfill demand requirements further comprises automatically executing purchase orders at the best available price among the one or more suppliers.

30. The method of claim 7 further comprising modifying said one or more collaboration models.

31. The method of claim 31 wherein said modifying is performed by way of a simple graphical user interface (GUI).
